(19) United States
(12) Patent Application Publication
(10) Pub. No.: US 2006/0059227 A1
(43) Pub. Date: Mar. 16, 2006

(54) Methods, systems and storage medium for displaying content in response to a consumer format preference

(76) Inventors: Randy Zimler, Gainesville, GA (US); William Whited, Atlanta, GA (US)

Correspondence Address: CANTOR COLBURN LLP, 55 GRIFFIN ROAD SOUTH, BLOOMFIELD, CT, 06002, US

(21) Appl. No.: 10/940,323

(22) Filed: Sep. 14, 2004

(51) Int. Cl. G06F 15/16

(52) U.S. Cl. 709/203

(57) ABSTRACT

A method of displaying content to a consumer including storing a consumer format preference and obtaining a request from the consumer to display the content. It is determined if the content meets the consumer format preference and the content is formatted to meet the consumer format preference if the content does not meet the consumer format preference. The content is then displayed.

### FIELD OF THE INVENTION

The present disclosure relates generally to displaying content and in particular, to displaying content to a consumer in response to a consumer format preference.

### BACKGROUND

Systems exist for distributing content to users such as broadcast television, cable television, pay-per-view, etc. In such systems, the content provider dictates when content is available and the user may view the content at the scheduled time. Devices such as video cassette recorders (VCRs) and digital video recorders (DVRs), such as the TiVo® system provided by TiVo Inc. of Alviso, Calif., allow users to time-shift content and view the content at a time different from the broadcast time.

Current systems either provide no user-defined selection of content format (e.g., pay per view) or require that the user specify the format of the content each time new content is viewed (e.g., DVD menus for language, format, etc.). This becomes burdensome on the consumer who must specify a desired format each time content is displayed.

### SUMMARY OF THE INVENTION

Embodiments of the invention include a method of displaying content to a consumer including storing a consumer format preference and obtaining a request from the consumer to display the content. It is determined if the content meets the consumer format preference and the content is formatted to meet the consumer format preference if the content does not meet the consumer format preference. The content is then displayed.

Embodiments of the invention include a system for displaying content including a consumer network, a controller on the consumer network and memory on the consumer network. The memory includes a consumer format preference for content. A content distribution network is in communication with the controller and includes a network element. The controller receives a request from the consumer to display the content and transmits the request and the consumer format preference to the network element. The network element determines if the content meets the consumer format preference and formats the content to meet the consumer format preference if the content does not meet the consumer format preference. The network element delivers the content to the controller and the controller initiates display of the content.

Embodiments of the invention include a system for displaying content comprising a consumer network, memory on the consumer network including a consumer format preference for content and a DVD player on the consumer network reading the content from a DVD. The DVD player determines if the content meets the consumer format preference and formats the content to meet the consumer format preference if the content does not meet the consumer format preference. A display on the consumer network displays the content.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 depicts an exemplary content distribution network in embodiments of the invention.

FIG. 2 depicts an exemplary consumer network in embodiments of the invention.

FIG. 3 depicts an exemplary user interface in embodiments of the invention.

FIG. 4 is a flowchart of an exemplary process for displaying content in embodiments of the invention.

FIG. 5 depicts exemplary content format fields in embodiments of the invention.

### DETAILED DESCRIPTION OF THE INVENTION

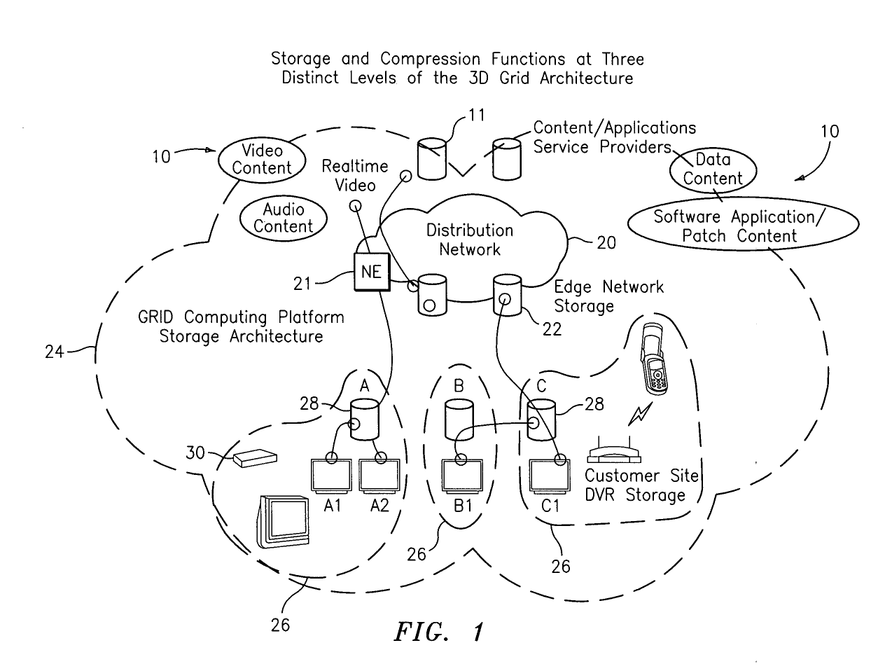

FIG. 1 depicts an exemplary video distribution architecture. The architecture is similar to that disclosed in U.S. patent application Ser. No. 10/605,928, filed Nov. 6, 2003 the entire contents of which are incorporated herein by reference. The video distribution architecture includes an underlying distribution network 20 and software infrastructure to support a video service platform. The major components of the architecture include content 10, the distribution network 20 (backbone and access), network storage 22, a grid computing platform 24, and consumer networks 26. It is understood that the consumer networks 26 are not limited to residential locations but may be any end user of the content.

The content 10 is made available through a distribution agreement between the content distribution system provider and the content owner. The content 10 may be a variety of audio-visual multimedia, such as television programs, movies, audio, consumer-generated content, etc. Consumer-generated content may be stored locally at consumer storage devices 28 (e.g., DVR) or at other storage elements on distribution network 20. There is a defined process for adding new content into the network and an associated profile including digital rights, subscription rules, quality of service (QOS), and billing rules. Content is stored within content provider storage 11, network storage 22 as well as on the consumer storage devices 28 (e.g., DVR) at the consumer sites.

The distribution network 20 includes the backbone and the edge network. An IP core provides the backbone network for content distribution. The IP core interfaces with a variety of access networks and access network technologies. This includes ADSL networks as well as open cable networks, wireless DSL networks, and other access networks as required.

The video distribution architecture includes storage within the distribution network at the content provider storage 11, the network storage 22, perhaps at a centralized locations (e.g., central offices within a telecommunications network, a cable head end) as well as at the consumer storage devices 28 at the consumers' sites (e.g., DVR devices). The network storage 22 supports transmission of real-time video that is archived for future viewing and supports the transportation of non-real-time video between storage devices (e.g., consumer-to-consumer).

The grid computing platform 24 controls components of the distribution network 20. The grid computing platform 24 is provided by network elements executing grid applications. As described in further detail herein, the grid computing platform 24 is implemented using processor-based network elements at a central office, at edges of the network, at the consumer location, etc. The grid applications control resources within the network including processing, bandwidth, and storage. The grid computing platform 24 provides the core applications platform for managing content and customer profiles including digital rights, subscriptions, billing, monitoring, etc.

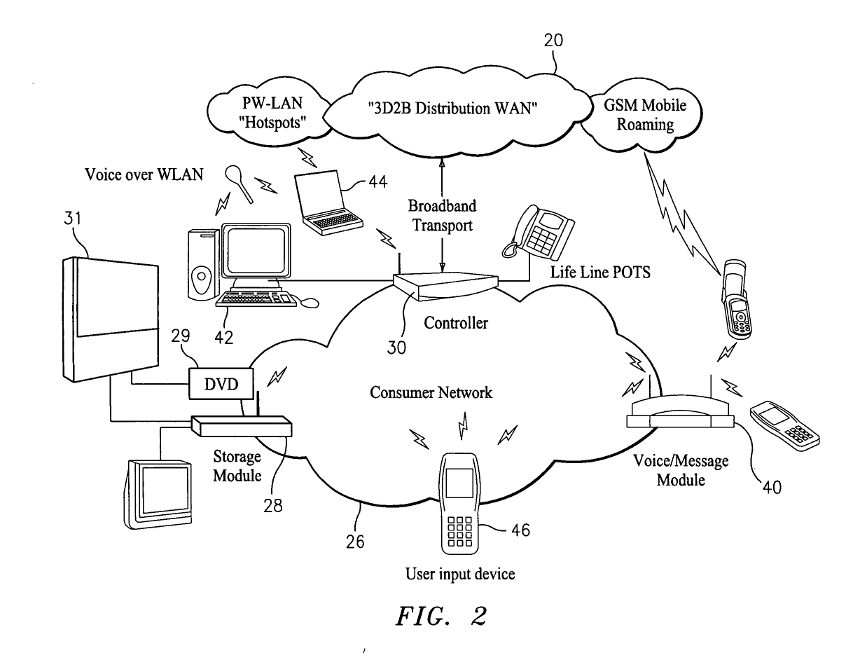

The consumer network 26 is the end user network that seamlessly unites all/any of the typical end-user's information appliances and devices as described in further detail with reference to FIG. 2. The consumer network 26 manages the receipt of content from the distribution network 20 and stores the content on one of the consumer storage devices 28 (e.g., DVR). The consumer network 26 may be based on a wireless networking standard such as 802.11e or wired network architectures such as a LAN, Ethernet, etc. or combinations or wired/wireless networking.

The distribution network 20 may include ADSL networks, open access cable, satellite, terrestrial broadcast and/or a wireless DSL platform. The distribution network 20 may be implemented over another ILEC's ADSL network or over cable modem access. The network operator derives value from the video service and the video revenue stream, not from the underlying access network. Further, the network owner may only need access to the underlying network rather than own the network outright.

The grid computing platform 24 is implemented using distributed network elements such as controller 30 (e.g., set-top box), the consumer storage devices 28 (which may be incorporated within controller 30), network storage devices 22 (e.g., at central office, data centers) and/or other network elements (e.g., processors at central office locations or other locations). The processor-based network elements may be implemented using a variety of components such as personal computers, servers, set top boxes, field programmable logic arrays, application specific integrated circuits, etc. These processor-based network element(s) determine based on consumer preference, consumer viewing habits or other reasons when to store a video program on the consumer storage device 28. Processor-based network element(s) decide where to store content that is not resident on the user's local consumer storage device 28. The grid computing platform 24 understands the network relationship between users to optimize network resources when content must be distributed from one consumer's storage device 28 to another consumer's storage device 28.

The grid computing platform 24 manages storage transparently to the consumer. The consumer is aware of the content they currently subscribe to and additional content that they may subscribe to in the future. The location of the content is transparent to the consumer. The consumer does not know and does not need to know if the content is on their local storage device 28 or being pulled from another storage device in the network. In FIG. 1, TV A1 pulls the program out of the resident DVR 28 while TV A2 displays real-time programming streamed over the distribution network 20. TV B1 pulls content from another consumer's DVR 28 while TV C1 pulls programming from a resident network storage device 22. Thus, content may be distributed from a variety of storage devices in the video distribution architecture.

FIG. 2 depicts an exemplary consumer network 26 in an embodiment of the invention. In one embodiment, the consumer network 26 is a residential home network, but similar networks may be employed in any setting where content is distributed. The consumer network 26 may be a wireless network that connects multiple devices using existing wireless network techniques (e.g., 802.11 g/e/i, 802.11b, HPNA, Power Line Carrier, UWB). The controller 30 is coupled to the distribution network 20 and serves as a gateway device between the consumer network 26 and the distribution network 20.

The consumer network 26 includes associated home devices such as, but not limited to, DVR, TV, PC, PDA, game consoles, telephone, etc. Content may be provided through controller 30 to the consumer's storage device 28 (which may be incorporated within controller 30). A voice/message module 40 provides for wireless telecommunications services. Voice data may also be distributed to a personal computer 42 or laptop 44. Thus, the consumer network 26 provides communication between devices as well as connecting the consumer storage device 28 back to the distribution network 20 for distributing content to other consumers. A DVD player 29 is connected to consumer network for playing DVDs.

The consumer network 26 includes a handheld user input device 46 and associated navigating software to command and control voice, data and video applications. The consumer network 26 has a common control platform for managing devices on the consumer network 26. This includes the ability to navigate through a video programming guide. A simple and functional user interface to content is one aspect of the content distribution network. This interface promotes watching pre-loaded content thereby reducing the bandwidth across the distribution network 20. The interface highlights the breadth of content available on demand to move the consumer away from valuing cable broadcast services based on the number of channels. The consumer selects content through user input device 46. The interface provides advanced flexible features such as pause, rewind, and fast forward that are not provided by the broadcasters without a CPE upgrade. The user input device 46 provides such features to guide the consumer through the program guide.

Content 10 may include differently formatted versions of the content. For example, movies formatted for DVD may include audio in multiple languages, subtitles in multiple languages, different scenes depending on the movie rating, different screen formats (e.g., wide screen or standard), different angles, etc. Often, a consumer desires to view content in a specific format. Embodiments of the invention collect consumer format preferences and format the content in response to the consumer-defined format preferences.

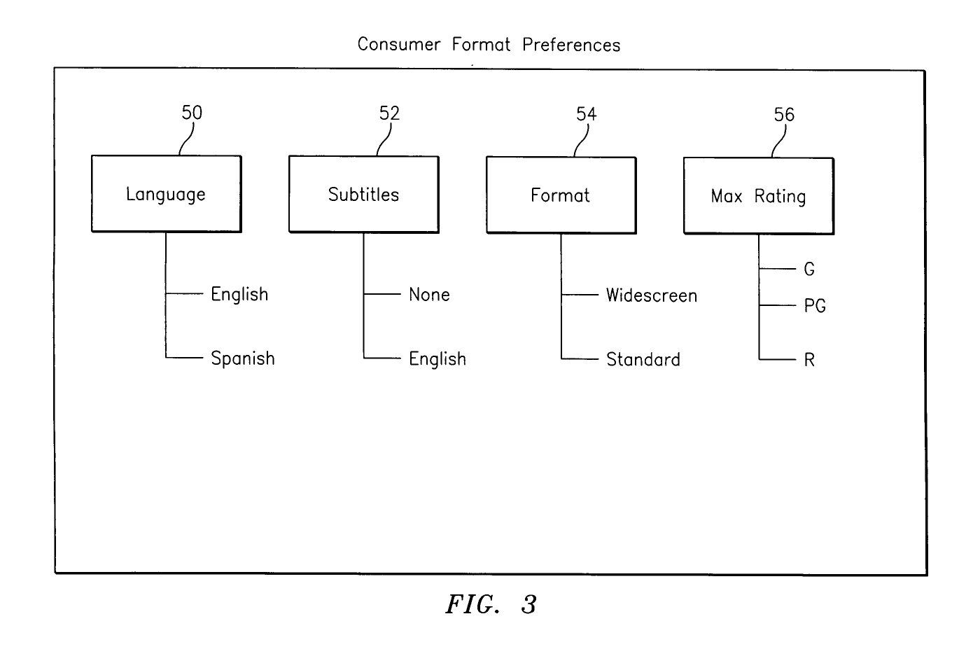

FIG. 3 depicts an exemplary user interface through which a consumer can establish consumer format preferences. The user interface may be generated by controller 30 (e.g., set top box) which is a processor-based network element operating in response to a computer program stored in a storage medium. The user interface may be accessed through user input device 46. Alternatively, DVD player 29 in the consumer network 26 may generate the user interface of FIG. 3.

Through the user interface, the consumer can specify consumer format preferences through a number of menus. The examples shown in FIG. 3 are related to movie content. Shown in FIG. 3 are a language icon 50, subtitle icon 52, format icon 54 and maximum rating icon 56. Through language icon 50, the consumer may designate a preferred language for an audio portion of the content. Through subtitle icon 52, the consumer may designate the presence of or the language of subtitles. Through format icon 54, the consumer may specify a display format for the content (e.g., widescreen, standard). Through the rating icon 56, the consumer may designate a maximum allowable movie rating for content. It is understood that other consumer format preferences may be designated through the user interface and that embodiments of the invention are not limited to those consumer format preferences depicted in FIG. 3.

Once the consumer has designated consumer format preferences through the user interface of FIG. 3, the consumer format preferences are stored in memory. The consumer format preferences may be stored in any memory on the consumer network 26 include controller 30, consumer storage device 28, DVD player 29 or television 31. The consumer format preferences may be stored on network storage 22 on the grid computing network 24 as well. The consumer format preferences are then used to format content to the consumer's preferences prior to viewing without requiring consumer involvement each time content is viewed.

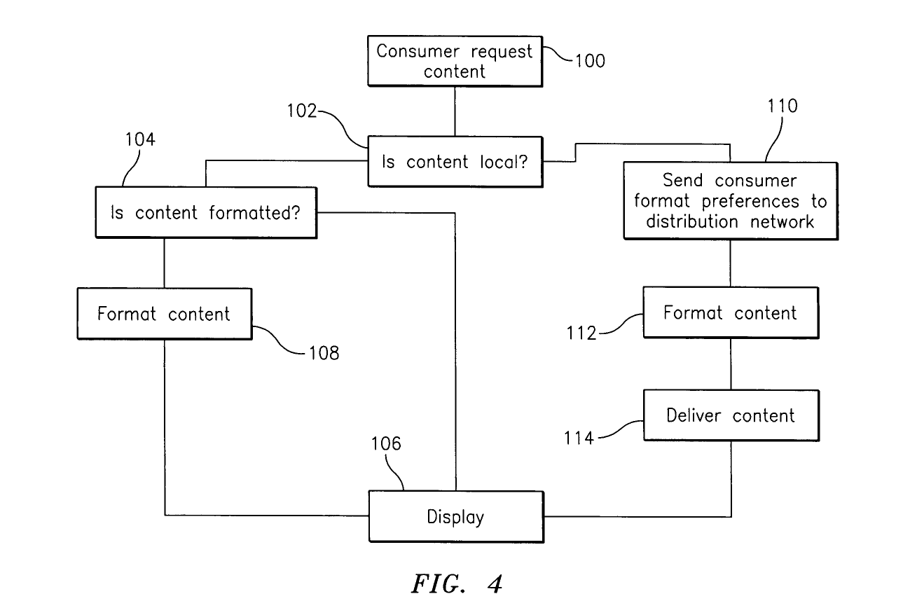

FIG. 4 is a flowchart of a process for presenting content to a consumer in response to consumer format preferences. The process begins at 100 when the consumer requests content to be displayed. The request may be in the form of loading a DVD, selecting a movie from storage device 28 or requesting video delivery from distribution network 20 through controller 30. At 102, controller 30 determines whether the content is local on the consumer network 26. For example, local content may be a movie stored on the consumer storage device 28 or a movie on a disc in DVD player 29. Remote content may be content that is available from content distribution network 20, but not on any device on the consumer network 26.

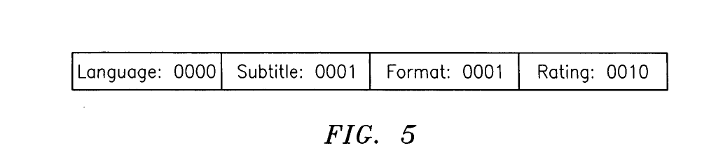

If the content is local, it is determined whether the content is already formatted based on the consumer format preferences at 104. For example, content stored on the consumer storage device 28 may be formatted based on the consumer format preferences. The content includes a header including fields that indicate the format applied to the content. FIG. 5 depicts exemplary content format fields that are associated with the content. Controller 30 compares the values in the content format fields to the consumer format preferences to confirm that the content is formatted accordingly.

If the local content is a DVD, the DVD player 29 can access consumer format preferences from a memory on the consumer network 26. The memory may be within the DVD player 29, in storage device 28, in controller 30 or in television 31. The DVD player 29 can then determine if the DVD content currently meets the consumer format preferences as described above.

If the local content is formatted in accordance with the consumer format preference, the process flows to 106 where the content is displayed. Typically, this involves providing the content to the consumer's television. If the content is not formatted in accordance with the consumer format preference, the content is formatted at 108. This may be performed by controller 30 accessing certain portions of the content from consumer storage device 28 or DVD player 29 accessing certain portions of the content from a DVD. For example, certain scenes may be omitted to comply with the consumer format preference for a maximum movie rating of PG-13. Further, English audio tracks are selected to match the consumer format preference. Current formatting of movies, such as DVD formats, facilitate such scene selection, audio track selection, etc. The formatted content is then displayed at 106.

If at 102, the content is not local on the consumer network 26, controller 30 requests the content from the content distribution network 20. As shown at 110, the request includes the consumer format preferences. The content distribution network 20 receives the request along with the consumer format preferences and formats the content in response to the consumer format preferences as shown at 112. The retrieval of content and formatting may be performed by one or more processor-based network elements 21 in the grid computing platform 24. As described above, the formatting may include selecting certain scenes (e.g., eliminating scenes that exceed a maximum movie rating), selecting audio in a preferred language, selecting scenes in a preferred format, etc. As the content is formatted in a segmented fashion (e.g., DVD format), the selection of scenes, audio tracks, etc. is facilitated.

At 114, the formatted content is then provided over distribution network 20 to the consumer network 26 through controller 30. Controller 30 stores the content on the consumer's storage device 28. The content is then displayed at 106.

The formatting of the content 10 prior to delivering the content to the consumer network 26 reduces bandwidth demands on the distribution network 20. By eliminating portions of the content 10 that are not desired by the consumer (e.g., scenes exceeding a maximum movie rating, unwanted audio tracks) the size of the content 10 is reduced. This reduces bandwidth requirements on the distribution network 20 and facilitates distribution.

As described above, embodiments can be embodied in the form of computer-implemented processes and apparatuses for practicing those processes. Exemplary embodiments are embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits and/or execute certain process flows.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method of displaying content to a display device on a consumer network, the method comprising:
storing a consumer format preference in memory on the consumer network;
obtaining a request from the consumer to display the content;
determining if the content meets the consumer format preference and formatting the content to meet the consumer format preference if the content does not meet the consumer format preference; and
displaying the content.

2. The method of claim 1 wherein:
the content is stored remote from the consumer network, the request to display content being a request to deliver the content over a content distribution network, the request including the consumer format preference.

3. The method of claim 1 wherein:
the content is stored on the consumer network.

4. The method of claim 3 wherein:
the content is stored on a consumer storage device.

5. The method of claim 3 wherein:
the content is stored on a DVD.

6. The method of claim 1 wherein:
the content includes a content format field indicating formatting applied to the content;
the determining includes comparing the content format field to the consumer format preference.

7. The method of claim 1 wherein:
the consumer format preference is stored in a controller on the consumer network.

8. The method of claim 1 wherein:
the consumer format preference is stored in a DVD player on the consumer network.

9. The method of claim 1 wherein:
the consumer format preference is stored in a television on the consumer network.

10. The method of claim 1 wherein:
the consumer format preference is a maximum movie rating.

11. A system for displaying content comprising:
a consumer network;
a controller on the consumer network;
memory on the consumer network, the memory including a consumer format preference for content;
a content distribution network in communication with the controller, the content distribution network including a network element;
the controller receiving a request from the consumer to display the content;
the controller transmitting the request and the consumer format preference to the network element;
the network element determining if the content meets the consumer format preference and formatting the content to meet the consumer format preference if the content does not meet the consumer format preference;
the network element delivering the content to the controller;
the controller initiating display of the content.

12. The system of claim 11 wherein:
the content includes a content format field indicating formatting applied to the content;
the network element comparing the content format field to the consumer format preference.

13. The system of claim 11 wherein:
the memory on the consumer network is in the controller.

14. The system of claim 11 wherein:
the consumer format preference is a maximum movie rating.

15. A system for displaying content comprising:
a consumer network;
memory on the consumer network, the memory including a consumer format preference for content;
a DVD player on the consumer network reading the content from a DVD;
the DVD player determining if the content meets the consumer format preference and formatting the content to meet the consumer format preference if the content does not meet the consumer format preference;
a display on the consumer network for displaying the content.

16. The system of claim 15 wherein:
the memory is in the DVD player.

17. The system of claim 15 wherein:
the memory is in a television.

18. The system of claim 15 wherein:
the consumer format preference is a maximum movie rating.
